(19) United States
(12) Patent Application Publication
(10) Pub. No.: US 2025/0346212 A1
(43) Pub. Date: Nov. 13, 2025

(54) WIPER BLADE CONNECTION DEVICE

(71) Applicant: VALEO SYSTEMES D'ESSUYAGE, La Verriere (FR)

(72) Inventors: Stephane HOUSSAT, La Verriere (FR); Vincent GAUCHER, La Verrière (FR); Guillaume MOULEYRE, La Verrière (FR); Olivier JOMARD, La Verrière (FR)

(73) Assignee: VALEO SYSTEMES D'ESSUYAGE, La Verriere (FR)

(21) Appl. No.: 18/866,608

(22) PCT Filed: May 17, 2023
(86) PCT No.: PCT/EP2023/063335

§ 371 Date: Nov. 18, 2024

(30) Foreign Application Priority Data
May 19, 2022 (FR) 2204814

(51) Int. Cl. B60S 1/40

(52) U.S. Cl. CPC B60S 1/40

(57) ABSTRACT

A connection device for connecting a wiper to an arm of a wiper system. The connection device extending in a longitudinal direction and including a connector configured to bear a wiper blade of the wiper and a connection module able to be mounted on the connector and including at least one base pivotably mounted about an axis of pivoting on the connector. The connector including at least one segment on which a pivot element cooperating with a pivot member of a longitudinal wall of the base is disposed. The base including load-reacting means which are borne by the longitudinal wall and which are configured such that the longitudinal wall and the load-reacting means are disposed transversely on either side of the segment of the connector.

### TECHNICAL FIELD

The field of the present invention is that of wiper systems intended for automotive vehicles. More particularly, the field of the present invention is that of connection devices disposed between a wiper arm and a wiper of such wiper systems.

### BACKGROUND OF THE INVENTION

Automotive vehicles are commonly fitted with wiper systems intended to clean their glazed surfaces, and notably their windshield. Such wiper systems comprise at least one wiper arm and a wiper driven by the wiper arm. The wiper arm is connected to an electric motor of the vehicle and the wiper comprises at least one wiper blade intended to come into contact with the glazed surface to be wiped.

In order to be able to drive the wiper, a connection device is arranged between this wiper and the wiper arm. More particularly, the connection device comprises an adapter arranged between the wiper arm and a connector connected to the wiper. The adapter is then secured to the wiper arm and more particularly to a free end of the wiper arm, such a cooperation being detachable such that it allows the wiper to be changed when it is worn.

Such a type of detachable connection is notably achieved by way of elastically deformable snap-fitting means. Such means have a flexibility that allows the connector to be engaged with and released from the adapter. These means are particularly convenient for the user to allow wiper replacements, but they can penalize the transmission of loads between the wiper arm and the wiper and generate bumps in the movement of the wiper due to the back and forth movement of the wiper arm bearing it, and in particular changes in the direction of the arm.

Furthermore, different types of wiper arms are currently fitted to automotive vehicles, forcing automotive equipment manufacturers to design different adapters specific to each type of arm, one adapter specifically linking one type of wiper arm to one connector. This feature firstly pushes automotive equipment manufacturers to develop many different adapters, including at least one for each type of wiper arm on the market, and secondly requires users needing to change their wiper to adapt and pay extra attention in order to select the correct adapter according to the type of wiper arm on which the wiper must be mounted.

It is therefore desired by the players in the automotive market to install connection modules that can be used as adapters for different types of wiper arm. The problem of reacting loads, and in particular transverse loads, between the arm and the wiper via the connection device is all the greater as the connection modules have a standard shape for several types of wiper arm and for example several components able to cooperate respectively with one or another type of wiper arm.

### SUMMARY OF THE INVENTION

The main subject of the present invention is a connection device for connecting a wiper to an arm of a wiper system, the connection device extending in a longitudinal direction and comprising a connector configured to bear a wiper blade of the wiper and a connection module able to be mounted on the connector, the connection module comprising at least one base pivotably mounted about an axis of pivoting on the connector, the base comprising at least one longitudinal wall bearing a pivot member, the connector comprising at least one segment on which a pivot element cooperating with the pivot member of the longitudinal wall is disposed, characterized in that the base comprises load-reacting means which are borne by the longitudinal wall and which are configured such that the longitudinal wall and the load-reacting means are disposed transversely on either side of the segment of the connector.

The wiper and the wiper arm form part of a vehicle wiper system intended to at least partially clean a glazed surface of said vehicle. The wiper system more particularly comprises the wiper arm, an electric motor configured to drive the rotation of the arm and allow, as the wiper moves as one with the arm via the connection device, a back and forth movement of the wiper along the glazed surface and cleaning of this glazed surface by a blade borne by the wiper.

As mentioned, the connection device comprises a connection module pivotably mounted on a connector secured to the wiper, this axis of pivoting allowing, in a known manner, the assembly formed by the connector and the wiper blade to pivot with respect to the wiper arm so as to adapt the position of the wiper against the glazed surface to be wiped during the back and forth movement of the wiper.

The presence of load-reacting means as mentioned above makes it possible to ensure that the transverse loads are transmitted from the base to the connector, regardless of the direction of movement of the wiper and therefore of the base, since the load-reacting means are at least partially offset transversely with respect to the longitudinal wall in order to be able to be disposed on either side of a segment of the connector, and, consequently, either the load-reacting means or the longitudinal wall are intended to be in contact with the part of the connector clamped between the load-reacting means and the longitudinal wall according to the direction of the transverse load caused.

The presence of the load-reacting means also makes it possible to distribute the transverse loads to the passage between the base and the connector and therefore to prevent too much load from being supported by the pivoting means which are borne respectively by the base and the connector and cooperate to ensure the pivoting of the connection module with respect to the connector. In this way, this transverse flanking of the segment optimizes the holding of the connection module on the connector, reducing the risk of deterioration of the pivoting means and consequently the risk of detachment of the connection module when the wiper and the connection device are driven in a back and forth movement on the glazed surface.

According to an optional feature of the invention, the load-reacting means comprise at least one portion offset transversely with respect to the longitudinal wall. It will be understood that this transversely offset portion extends mainly in a plane parallel to and separate from the plane in which the longitudinal wall mainly extends.

According to another optional feature of the invention, the load-reacting means comprise a bearing portion extending mainly in a plane parallel to and separate from the plane in which the longitudinal wall mainly extends, and a connecting portion disposed between the bearing portion and the longitudinal wall, the segment of the connector being flanked transversely between the longitudinal wall and the bearing wall of the load-reacting means.

According to another optional feature of the invention, the base comprises at least one pair of load-reacting means, first load-reacting means extending at a first transverse end of the base, second load-reacting means extending at a second transverse end of the base, the first load-reacting means flanking with a first longitudinal wall of the base a first segment of the connector, the second load-reacting means transversely flanking with a second longitudinal wall of the base a second segment of the connector. In other words, each segment of the connector is flanked transversely by load-reacting means and a longitudinal wall of the base.

According to another optional feature of the invention, the base comprises additional load-reacting means disposed at a longitudinal end of a longitudinal wall which is opposite the longitudinal end where the load-reacting means are disposed.

According to another optional feature of the invention, the additional load-reacting means comprise a fin which is offset transversely with respect to the longitudinal wall and which extends mainly substantially in the same plane as that in which the bearing wall of the load-reacting means mainly extends.

Alternatively, provision may be made for the base to comprise, on one transverse side, load-reacting means as described above, and, on the other transverse side, additional load-reacting means, with the load-reacting means and the additional load-reacting means which are disposed in opposition, that is to say situated at opposite longitudinal ends and respectively on one of the longitudinal walls.

According to another optional feature of the invention, the pivot element is disposed longitudinally between the load-reacting means and the additional load-reacting means.

According to another optional feature of the invention, the connector comprises at least one support wall having an upper face participating in defining a housing of the base of the connection module, the connector comprising two segments extending parallel to one another from the upper face in the vertical direction toward the base, the support wall of the connector being extended vertically by two transverse end walls disposed at the transverse ends of the support wall and extending in a direction opposite to the segments, the load-reacting means being disposed facing an outer face of one of the lateral walls.

According to another optional feature of the invention, the base comprises at least one pair of additional load-reacting means, first additional load-reacting means extending at a first transverse end of the base, second additional load-reacting means extending at a second transverse end of the base, the first additional load-reacting means being able to extend facing a first lateral wall of the connector, the second additional load-reacting means being able to extend facing a second lateral wall of the connector.

According to another optional feature of the invention, the connection module further comprises a rotary platform rotationally mounted about an axis of rotation on the base, the axis of pivoting and the axis of rotation extending perpendicularly with respect to the longitudinal direction. In other words, the connection module is split into at least two rotary parts rotating with respect to one another, namely the base which ensures the function of pivoting of the connection module with respect to the connector, as mentioned above, and the rotary platform which is movably mounted with respect to the base.

According to another optional feature of the invention, the axis of rotation is formed at one of the longitudinal ends of the base. More particularly, it may be provided that the axis of pivoting extends at the center of the base, whereas the axis of rotation extends at one of the longitudinal ends of the base.

The longitudinal offset between the two parts of the connection module makes it possible to generate an angular movement of the platform with respect to the base which is sufficient so that, in a position in which the platform is released from the base, the platform can cooperate with different types of wiper arm independently of the base, the platform and the base being moreover configured to lock the position of these different types of wiper arm once the position of the platform is fixed with respect to that of the base. A connection module according to the invention thus makes it possible to combine a wiper and a connection device associated with a multiplicity of different types of arm, which can be connected to the connection device both when the rotary platform is pressed against the base and when the rotary platform is at a distance from the base. The presence of load-reacting means and, where appropriate, additional load-reacting means is all the more important in the exemplary embodiment of a connection module comprising a rotary platform mounted on the base, since they prevent the transverse loads from increasing at each of the stages forming the connection device.

According to an optional feature of the invention, the base comprises a frame comprising two longitudinal walls and two transverse walls extending perpendicularly and between the two longitudinal walls, a first transverse wall being disposed at a first longitudinal end of the longitudinal walls and a second transverse wall being disposed at a second longitudinal end of the longitudinal walls, at least one longitudinal wall bears an extension flank extending in the main plane of extension of the longitudinal wall toward the connector, the extension flank participating in delimiting the pivot member cooperating with the pivot element of the connector. It will be understood here that the pivot element borne by the segment cooperates with the pivot member which is itself disposed on the extension flank of the longitudinal wall.

According to another optional feature of the invention, the pivot member comprises a tongue delimited longitudinally by at least one vertical groove formed in the extension flank, the tongue bearing a peg extending transversely toward the outside of the base.

According to another optional feature of the invention, the tongue is movable about a bending axis parallel to the longitudinal direction.

According to another optional feature of the invention, the two segments each comprise a pivot element, the base comprising at least two pivot members intended to cooperate with one or the other of the pivot elements in such a way as to form a pivot device between the connector and the base.

According to another optional feature of the invention, the pivot element comprises an orifice which passes through the segment in the pivoting direction and is intended to cooperate with a peg borne by the base and forming the pivot member.

According to another optional feature of the invention, the connection device comprises a covering member dimensioned to cover at least the connection module, the load-reacting means being configured to present an impression of complementary shape to that of a lower edge of the covering member.

A subject of the present invention is also a wiper comprising a wiper blade and a connection device according to any one of the preceding features.

The present invention also relates to a wiper system comprising at least one wiper arm and a wiper according to the preceding feature, the wiper being disposed at one end of the wiper arm, the wiper arm being secured to the wiper through cooperation with the connection device.

### BRIEF DESCRIPTION OF DRAWINGS

Other features, details and advantages of the invention will become more clearly apparent on reading the description of several exemplary embodiments given by way of non-limiting indication with reference to the appended schematic drawings, in which:

FIG. 1 is a perspective representation of a wiper on which a connection device according to the invention is mounted;

FIG. 2 is an exploded view of the wiper and the connection device shown in FIG. 1;

FIG. 3 is a perspective view of a connector, a connection module, a cover and a covering element forming the connection device shown in FIG. 1;

FIG. 4 is a view similar to that in FIG. 3 and in which the covering element has been removed to make visible the base and the rotary platform forming the connection module;

FIG. 5 is a perspective representation of the connector shown in FIG. 3;

FIG. 6 is a perspective representation from above of the base shown in FIG. 4;

FIG. 7 is a perspective representation from below of the base shown in FIG. 4; and

FIG. 8 is a sectional view, in a longitudinal and transverse plane, of a base and a connector shown in FIG. 4.

The features, variants and different embodiments of the invention may be combined with one another, in various combinations, as long as they are not mutually incompatible or mutually exclusive. It will be possible, in particular, to imagine variants of the invention that comprise only a selection of the features described below, in isolation from the other features described, if this selection of features is sufficient to confer a technical advantage and/or to distinguish the invention from the prior art.

In the figures, elements that are common to several figures retain the same reference signs.

### DETAILED DESCRIPTION OF THE INVENTION

In the detailed description which follows, the terms “longitudinal”, “transverse” and “vertical” refer to the orientation of a wiper system according to the invention. A longitudinal direction corresponds to a main direction of elongation of a wiper of the wiper system, this longitudinal direction being parallel to a longitudinal axis L of a frame of reference L, V, T illustrated in the figures. A vertical direction corresponds to a direction of stacking of a connector, a base and a rotary platform of a connection device of the wiper system, this vertical direction being parallel to a vertical axis V of the frame of reference L, V, T and this vertical axis V being perpendicular to the longitudinal axis L. Lastly, a transverse direction corresponds to a direction parallel to a transverse axis T of the frame of reference L, V, T, this transverse axis T being perpendicular to the longitudinal axis L and the vertical axis V.

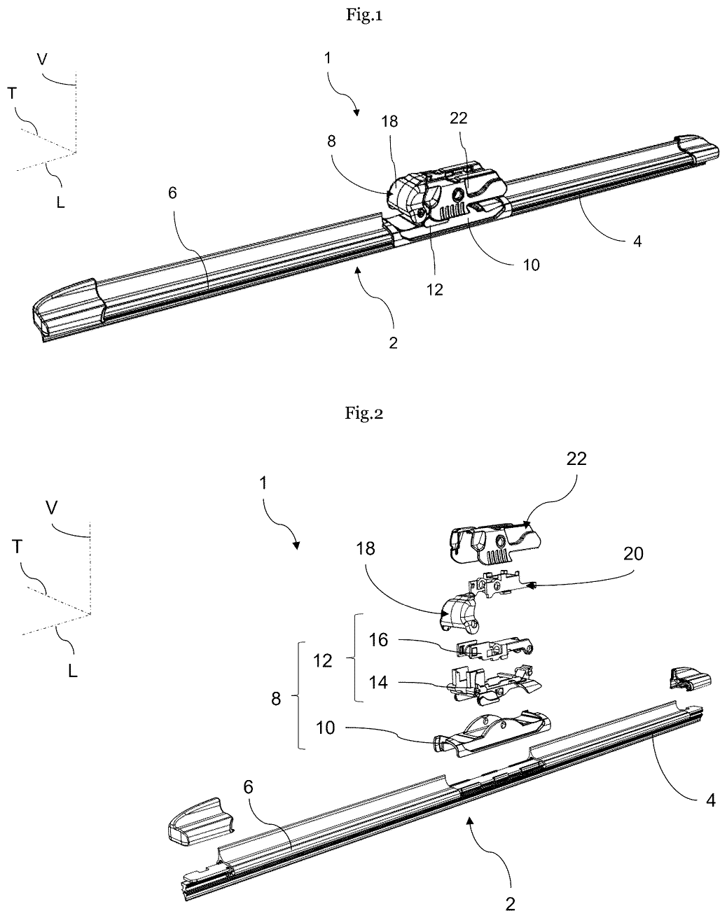

FIG. 1 illustrates a wiper system 1 configured for cleaning a glazed surface of a vehicle, for example a windshield, so as to improve a driver's view of the road in front of the vehicle. The wiper system 1 comprises at least one wiper arm, not shown in FIG. 1, bearing at one end a wiper 2 which extends mainly in the longitudinal direction L.

The wiper 2 comprises at least one wiper blade 4, intended to be in contact with the glazed surface to be cleaned, and a support 6 for said wiper blade 4.

The wiper 2 is also secured to the wiper arm by a connection device 8. The connection device 8 according to the invention comprises a connector 10 and a connection module 12 pivotably mounted on the connector 10, the latter being secured to the wiper 2 while the connection module 12 is configured to be secured to the wiper arm of the wiper system 1.

The pivotable mounting of the connection module 12 on the connector 10 thus makes it possible for the wiper 2 to be pivoted at one of the ends of the wiper arm, and to thus ensure that the wiper blade 4 is pressed against the glazed surface to be wiped.

In the example illustrated, and as can be seen in FIG. 2 to FIG. 4, the connection module 12 comprises a base 14, pivotably mounted about an axis of pivoting P on the connector 10, and a rotary platform 16 rotationally mounted about an axis of rotation R on the base 14.

It should be noted that according to the invention, and as will be described in detail below, the connection device is notable in that it comprises load-reacting means, and where appropriate additional load-reacting means, which are borne by the connection module and more particularly by a longitudinal wall of a base of this connection module, and which are configured so as to transversely flank, with the longitudinal wall of the base, a wall of the connector. Such a configuration can be implemented independently of the presence of a rotary platform pivotably mounted on the base. In the description which follows, details will be given about the structure of the rotary platform, without this being limiting for the invention.

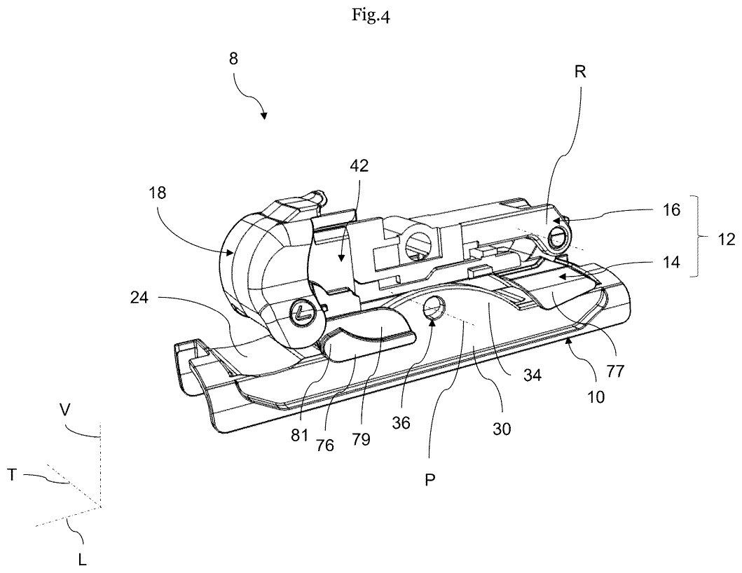

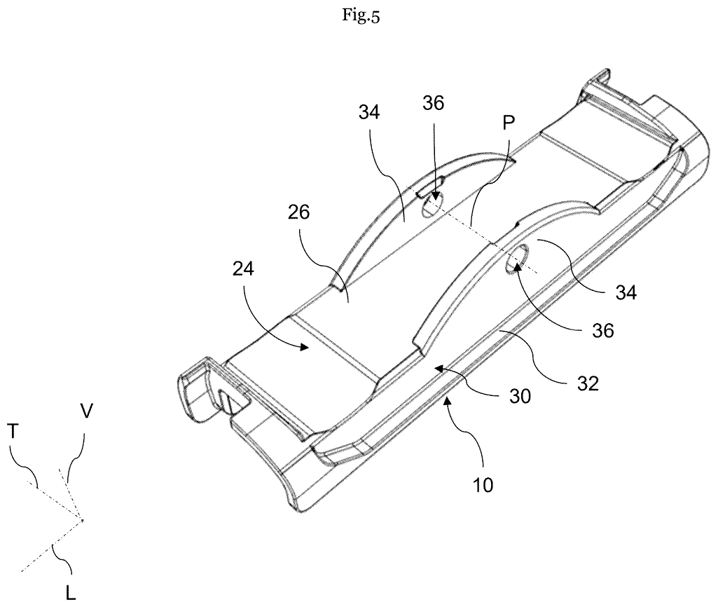

In the example illustrated, the connection device 8 comprises three members, namely the connector 10, the base 14 and the rotary platform 16, articulated in pairs so as to allow, for the one part, the connector 10, and by extension the wiper 2, to be pivoted with respect to the connection module 12 and, for the other part, different types of wiper arm to be mounted on the connection module 12. As can be seen more particularly in FIG. 4, the axis of pivoting P and the axis of rotation R may extend parallel to and separately from one another. In the example illustrated, the axis of pivoting P is formed substantially at the center of the base 14, relative to the longitudinal dimension of this base, and the axis of rotation R is formed at one of the longitudinal ends of the base 14. The longitudinal offset of the axis of rotation with respect to the axis of pivoting P and the axis of rotation R allows the rotary platform to be tilted into a mounting position which is inclined with respect to the longitudinal and transverse plane of the base, the tilting of this rotary platform allowing certain types of wiper arm to be mounted on this connection device 8.

The axis of pivoting P and the axis of rotation R may be offset vertically with respect to one another.

The connection device 8 may also comprise a cover 18 pivotably mounted about a pivot axis A parallel to the axis of pivoting P and to the axis of rotation R. The pivot axis A is formed at a longitudinal end of the base 14 which is opposite the longitudinal end where the axis of rotation R is formed. The cover 18 is configured to be movable between a covering position, fixing certain types of wiper arms to the connection device 8, and a release position, allowing certain types of wiper arm to be mounted on the connection device 8.

Furthermore, the connection device 8 may comprise, as can be seen in FIG. 2, a removable adapter 20 configured to be fastened to the rotary platform 16 and to enable the cooperation between the connection device 8 and certain types of wiper arm which cannot be fastened directly to the rotary platform.

By way of example, the adapter comprises studs protruding in the direction away from the rotary platform and delimiting at least one channel allowing the positioning of a holding tab of a particular type of wiper arm, and/or the adapter comprises at least one locking tongue against which another type of wiper arm can bear.

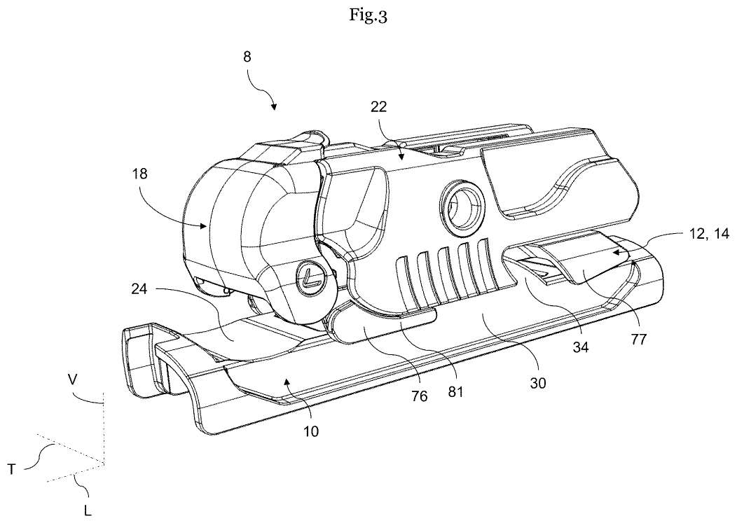

In this example, as can be seen more particularly in FIG. 2 and FIG. 3, the connection device 8 may comprise a covering member 22 which is secured to the rotary platform 16 and/or to the base 14 and at least partially covers the connector 10, the rotary platform 16 and/or the base 14. The covering member 22 permits the cooperation between the connection device 8 and certain types of wiper arm.

The connector 10 will now be described in more detail, notably with reference to FIG. 5.

The connector 10 has a support wall 24 extending substantially parallel to the longitudinal L and transverse T directions, the support wall 24 having an upper face 26 facing the connection module 12 and a lower face facing the wiper 2. More particularly, the lower face of the support wall 24, not visible in FIG. 5, participates in delimiting a housing of the wiper and notably the support 6 for the wiper blade 4.

The connector 10 comprises two lateral walls 30 extending at each of the transverse ends of the support wall 24, each of the lateral walls 30 being inscribed in a plane substantially parallel to the longitudinal L and vertical V directions. The lateral walls 30 each have a clearance 32 on their outer face, each clearance 32 being formed by a removal of material from the upper edge of the corresponding lateral wall and extending longitudinally between the two longitudinal ends of the connector 10.

The connector 10 comprises two segments 34 which extend parallel to one another and protrude from the upper face 26 of the upper wall, each segment 34 extending a lateral wall 30 of the connector 10. These two segments 34, which extend on the opposite side to the lower face of the support wall 24, participate in at least partially delimiting a housing of the base 14. The segments 34 each have a convexly curved free end, and are symmetrical to one another with respect to a median plane of the connector 10 parallel to the longitudinal L and vertical V directions.

At least one of the two segments 34 comprises a pivot element 36 able to cooperate with a pivot member 38 of the base 14 in such a way as to form a pivot device between the connector 10 and the base 14. Preferably, each of the two segments 34 comprises a pivot element 36 cooperating with a corresponding pivot member 38 of the base 14, the orifices of the pivot elements 36 being aligned in the transverse direction T.

The pivot element 36 in this case takes the form of an orifice formed in the segment 34, in this case an orifice passing transversely through the segment 34, while the pivot member 38 takes the form of a peg intended to extend at least partially into the orifice. The cooperation between the orifice and the peg thus forms the pivot device.

The pivot element 36 is in this case disposed at the center of the segment 34 in the longitudinal direction L, that is to say that it is disposed equidistantly from each of the longitudinal ends of the segment 34 in the longitudinal direction L. The centered arrangement of the pivot element 36 makes it possible in particular to balance the pivoting of the wiper 2 with respect to its arrangement at the end of the wiper arm.

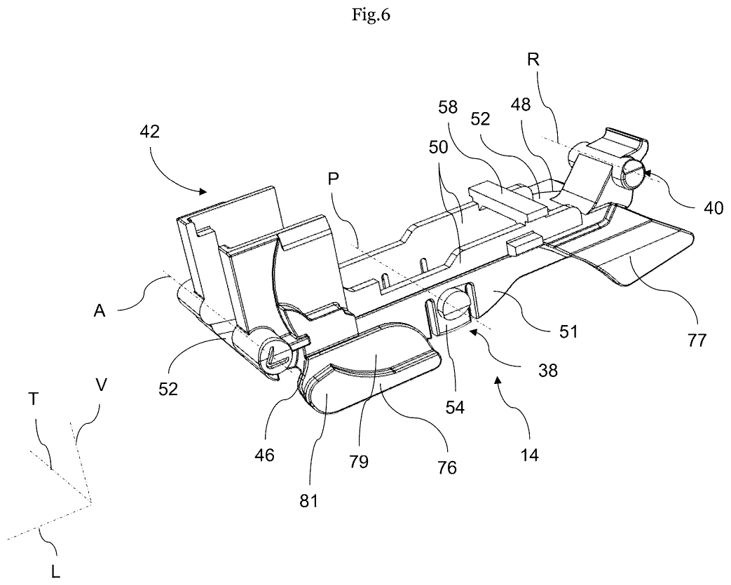

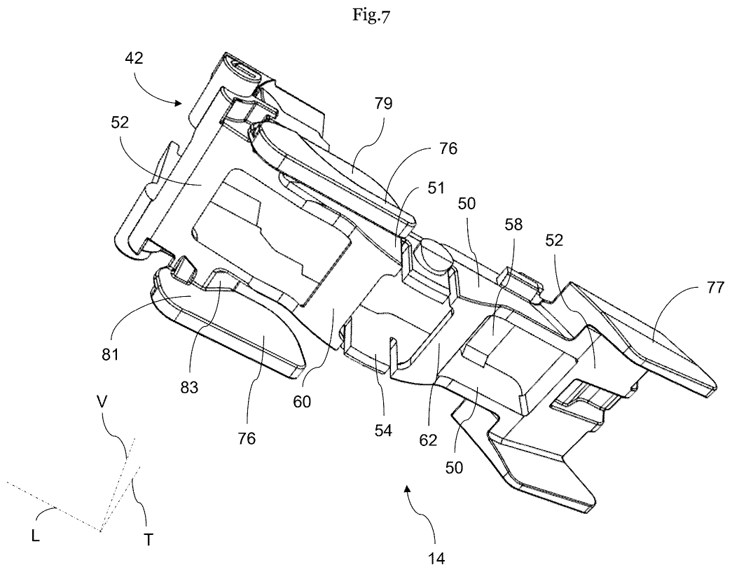

The base 14 of the connection module 12 will now be described in more detail, notably with reference to FIG. 6 and FIG. 7.

The base 14 comprises a rotation member 40 able to cooperate with the rotary platform 16, in order to allow the platform to rotate with respect to the base about the axis of rotation R, and a guide block 42 intended to receive a free end of the rotary platform 16. The base 14 extends longitudinally, having a first longitudinal end 46 in the vicinity of which the guide block 42 is disposed, and a second longitudinal end 48 in the vicinity of which the rotation member 40 is disposed. The guide block 42 is intended to receive, in addition to the free end of the rotary platform 16, a particular type of wiper arm and thus to participate in securing it to the connection module 12. The rotation member 40, for its part, allows the rotation of the rotary platform 16 between a first position in which the free end of the rotary platform 16 is disposed in the guide block 42 and a second position in which the free end of the rotary platform 16 is disposed at a distance from the guide block 42.

In other words, it can be defined that the rotary platform 16 is movable between a first working position in which the rotary platform 16 is received in the guide block 42 of the base 14 and a second mounting position in which the free end of the rotary platform 16 is disposed at a distance from the guide block 42.

The base 14 comprises a frame comprising at least two longitudinal walls 50 extending in the longitudinal direction L between the first longitudinal end 46 and the second longitudinal end 48 parallel to one another, and two transverse walls 52 extending perpendicularly and between the longitudinal walls 50, a first transverse wall 52 being disposed at the first longitudinal end 46 of the structure and facing the guide block 42 while the second transverse wall 52 is disposed at the second longitudinal end 48 and bears the rotation member 40. In other words, the transverse walls 52 extend parallel to the transverse direction T, in such a way as to form with the longitudinal walls 50 the frame bearing at least the guide block 42 and the rotation member 40.

At least one longitudinal wall 50 has an extension flank 51 extending in a plane which is coincident with the main plane of extension of the longitudinal wall 50 and bearing the above-mentioned pivot member 38 configured to cooperate with the pivot element 36 of the connector 10. It will be understood that the peg of the pivot member 38 extends toward the outside of the longitudinal wall 50 bearing it, i.e. away from the other longitudinal wall, in order to cooperate with the orifice of the pivot element 36 borne by the corresponding segment 34 of the connector 10.

More precisely, the pivot member 38 comprises a tongue 54 delimited longitudinally by at least one vertical groove formed in the longitudinal wall 50, the tongue 54 bearing the peg extending transversely toward the outside of the base 14. The tongue 54 extends mainly in the vertical direction V, such that a bending axis of the tongue 54 extends parallel to the longitudinal direction L. The bending of the tongue 54 enables the mounting of the base 14 on the connector 10, the tongue 54 being movable about the bending axis during the mounting of the base 14 on the connector 10 so as to return to its initial position once the peg extends at least partially into the orifice of the segment 34.

The longitudinal walls 50 are spaced apart from one another such that they extend between the segments 34 of the connector 10 when the base 14 is fastened to the connector by snap-fitting, the base 14 extending at least partially into the housing defined by the segments 34 of the connector 10 as outlined above.

As can be seen more particularly in FIG. 6 and FIG. 7, the base 14 comprises at least one reinforcing bridge 58 connecting the upper edges of the two longitudinal walls 50 in the transverse direction T parallel to the axis of pivoting P. The reinforcing bridge 58 makes it possible to stiffen the frame of the base 14, in particular to ensure that the two longitudinal walls are spaced apart from one another and to ensure that the pegs forming the pivot member 38 remain engaged in the orifices forming the pivot element 36 even when transverse loads are applied to the connection module 12 by the wiper arm. In addition, the reinforcing bridge 58 has a transverse dimension that is greater than the transverse dimension between the two longitudinal walls, such that the two transverse ends of the reinforcing bridge extend transversely beyond the longitudinal walls 50.

The base 14 comprises a first reinforcing bar 60 and a second reinforcing bar 62, visible in FIG. 7 and extending transversely between the two lower edges of the longitudinal walls 50 on either side of the pivot member 38. The reinforcing bars 60, 62 have a function similar to that of the reinforcing bridge 58 extending over the upper edges of the longitudinal walls 50, that is to say stiffening of the frame of the base 14 in order to limit deformation of said frame when the connection device 8 is subjected to transverse loads.

According to the invention, as mentioned above, the base 14 comprises at least load-reacting means 76 configured to allow the transmission of transverse loads, that is to say the loads to which the connection device is subjected parallel to the pivoting direction of the connection module 12 with respect to the connector 10. At least first load-reacting means are borne by one of the longitudinal walls 50.

More particularly, the load-reacting means 76 are characterized in that a part, more particularly referred to as a bearing portion 81 hereinafter, is disposed facing the corresponding longitudinal wall 50 so as to transversely flank a wall of the connector, and in particular a segment of the connector. The part of the load-reacting means facing the longitudinal wall extends in a plane parallel to the planes in which the longitudinal walls 50 are respectively inscribed, the load-reacting means 76 forming a protrusion from the corresponding longitudinal wall, extending vertically away from the upper edge of this longitudinal wall. Preferably, the base 14 comprises a pair of load-reacting means 76 extending on either side of the base 14, each of the load-reacting means 76 comprising a bearing portion 81 extending in a plane parallel to the longitudinal walls 50 and at a distance from the latter, delimiting a housing for a segment 34 of the connector 10.

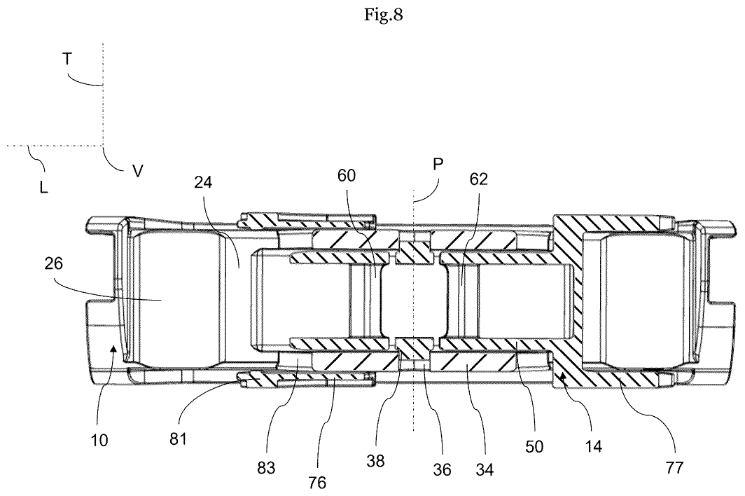

As illustrated in FIG. 3, FIG. 4 and FIG. 8, the base 14 is configured such that a longitudinal wall 50 and the load-reacting means 76 which form a protrusion from this longitudinal wall are disposed transversely on either side of a segment 34 of the connector 10. In other words, at least one segment 34, in this case each of the segments 34, is flanked transversely by one of the longitudinal walls 50 and by load-reacting means 76 of the base 14. By virtue of this flanking, the longitudinal wall 50 or the load-reacting means 76 are brought into contact with the connector 10, in the direction of a load exerted transversely on the connector 10, and thus allow the transverse loads to be reacted regardless of the direction of the loads.

More particularly, the load-reacting means 76 comprise a bearing portion 81, which is offset transversely with respect to the associated longitudinal wall 50 and which extends parallel to the plane in which this longitudinal wall 50 is mainly inscribed, and a connecting portion 83, which is disposed between the bearing portion 81 and the longitudinal wall 50 and which for this purpose extends substantially perpendicularly to the bearing portion 81. In this context, the segment 34 of the connector 10 is flanked transversely between the longitudinal wall 50 and the bearing portion 81 of the load-reacting means 76.

The connecting portion 83, which makes it possible to secure the bearing portion 81 to the longitudinal wall 50, may have a chamfer making it possible to avoid contact between this connecting portion and a segment of the connector and thus making it possible not to hinder the pivoting of the base on the connector, as can be seen in FIG. 7 in particular.

The bearing portion 81 is offset transversely with respect to the longitudinal wall by a dimension slightly greater than the thickness, that is to say in this case the transverse dimension, of the segment 34, and this makes it possible, for the one part, to ensure that the segment 34 is disposed facing the outer face of the longitudinal wall 50 and an inner face of the bearing portion 81 of the load-reacting means 76, and, for the other part, to allow a minimal clearance to be formed between the segment and each of these faces facing the segment in order to allow an effective reaction of loads.

The aim of the flanking of the segment 34 of the connector 10 by the load-reacting means 76 and the longitudinal wall 50 is in fact to facilitate the transmission of loads between the wiper arm and the wiper during the back and forth movement of the arm, in order to avoid as much as possible jerks in the movement of the wiper. A transverse load transmitted to the connection module by the fastening of the rotary platform, via an adapter removably fastened to this platform where appropriate, to the wiper arm can thus be effectively transmitted to the connector 10 via the base 14 and the close mounting formed according to the invention between, on the one hand, the segment of the connector and, on the other hand, the load-reacting means 76 and the longitudinal wall 50 of the base.

Preferably, the base 14 comprises a pair of load-reacting means 76 extending transversely on either side of the base 14, each of the load-reacting means 76 comprising a bearing portion 81 extending parallel to and facing a respective longitudinal wall 50 and at a distance from the latter so as to delimit a housing for a segment 34 of the connector 10 in order to react transverse loads as described above.

More particularly, first load-reacting means 76 extend at a first transverse end of the base 14, second load-reacting means 76 extending for their part at a second transverse end of the base 14, the first load-reacting means 76 flanking with a first longitudinal wall 50 a first segment 34 of the connector 10, the second load-reacting means 76 transversely flanking with a second longitudinal wall 50 a second segment 34 of the connector 10. In other words, and preferably, each segment 34 of the connector 10 is flanked transversely by one of the load-reacting means 76 and one of the longitudinal walls 50. This allows an effective reaction of loads, whether the transverse load is in one direction or another.

The connecting portion 83 of each of the load-reacting means is in this case formed substantially in the transverse continuation of one of the transverse walls and the bearing portion 81 extends longitudinally toward the other transverse wall so as to cover the corresponding segment 34 of the connector 10. The arrangement of the connecting portion 83 of each of the load-reacting means 76 at the transverse ends of the transverse wall 52 is advantageous in that the transverse walls 52 participate in stiffening the frame of the base 14, such that the load-reacting means 76 have less tendency to deform upon contact with the segment under transverse load.

The load-reacting means 76 may have an impression 79 whose pattern is complementary to the shape of the lower edge of the covering member 22, such that the load-reacting means do not hinder the movement of the covering member 22 and that, on the contrary, they make it possible to form an aerodynamic assembly without the presence of the covering member implying the presence of protruding edges that penalize the circulation of aerodynamic flows. More particularly, this impression 79 is made in the outer face of the bearing portion 83, opposite the segment 34 of the connector which the load-reacting means are caused to cover. It will be understood that when the covering member 22 is in position on the connection module, this covering member has lateral walls which laterally cover the connection module and therefore the base, such a lateral wall extending mainly in a plane that is partially coincident with that of the load-reacting means 76. The production of the impression 79 enables this lateral wall to be inscribed within the thickness of the load-reacting means and in particular within the bearing portion of these load-reacting means and therefore not to hinder the pivoting of the covering member.

In addition to what has just been described, the base 14 may comprise additional load-reacting means 77 disposed at a longitudinal end 48 of a longitudinal wall 50 opposite the longitudinal end 46 where the load-reacting means 76 associated with this longitudinal wall are disposed, the load-reacting means 77 comprising at least one fin extending substantially in the same plane as the bearing portion 83 of the load-reacting means 76. In accordance with what has been said above, the additional load-reacting means 77, and more particularly the fin, then extend in a plane parallel to and separate from the plane in which the longitudinal wall 50 extends, that is to say being offset transversely with respect to the longitudinal wall 50.

Advantageously, the base 14 comprises a pair of additional load-reacting means 77 extending transversely on either side of the base 14, each of the load-reacting means 77 being offset transversely with respect to the corresponding longitudinal wall 50 so as to delimit a housing for a lateral wall 30, or a segment 34, of the connector 10.

More particularly, first additional load-reacting means 77 extend at a first transverse end of the base, and more particularly in this case at a first transverse end of the transverse wall 52 disposed opposite the load-reacting means 76, second additional load-reacting means 77 extending for their part at a second transverse end of this transverse wall 52. The first additional load-reacting means 77 flank with a first longitudinal wall 50 a first lateral wall 30, or a first segment 34, of the connector 10, and the second additional load-reacting means 77 transversely flank with a second longitudinal wall 50 a second lateral wall 30, or a second segment 34, of the connector 10. In other words, and preferably, each lateral wall 30, or each segment 34, of the connector 10 is flanked transversely by one of the additional load-reacting means 77 and one of the longitudinal walls 50.

The arrangement of the additional load-reacting means 77 at the transverse ends of a transverse wall 52 again makes it possible to improve the resistance to transverse loads of the additional load-reacting means 77.

As can be seen in particular in FIG. 6 and FIG. 7, for a given longitudinal wall 50, the pivot member 38 is disposed longitudinally between the load-reacting means 76 and the additional load-reacting means 77. In this way, when the base 14 pivots about the axis of pivoting P, at least one or the other of the load-reacting means 76 or the additional load-reacting means 77 is facing the segment 34 and/or the lateral wall 30, and it is thus possible to ensure flanking of a portion of the connector with the load-reacting means and/or the additional load-reacting means and the associated longitudinal wall 50, so as to ensure, regardless of the position occupied by the base 14 with respect to the connector 10, the reaction of transverse loads as mentioned above.

It follows from what has just been described that the invention achieves the aims which it has set itself, namely to propose an optimal transmission and distribution of transverse loads between a wiper arm and a wiper via an appropriate connection device, notably through the implementation of at least load-reacting means formed on the connection module mounted tiltably on the connector, these additional load-reacting means having a transversely offset portion so as to be able to flank a segment of the connector with a longitudinal wall from which it protrudes.

However, the present invention is not limited to the means and configurations described and illustrated here and it also extends to any equivalent means and configuration and to any technically operational combination of such means.

What is claimed is:

1. A connection device for connecting a wiper to an arm of a wiper system, the connection device extending in a longitudinal direction and comprising a connector configured to bear a wiper blade of the wiper and a connection module able to be mounted on the connector, the connection module including at least one base pivotably mounted about an axis of pivoting on the connector, the base including at least one longitudinal wall bearing a pivot member, the connector including at last one segment on which a pivot element cooperating with the pivot member of the longitudinal wall is disposed, wherein the base includes load-reacting means which are borne by the longitudinal and which are configured such that the longitudinal wall and the load-reacting means are disposed transversely on either side of the segment of the connector.

2. The connection device as claimed in claim 1, wherein the load-reacting means include a bearing portion extending in a plane parallel to that in which the longitudinal wall extends and a connecting portion disposed between the bearing portion and the longitudinal wall, the segment of the connector being flanked transversely between the longitudinal wall and the bearing wall of the load-reacting means.

3. The connection device as claimed in claim 1, wherein the base includes at least one pair of load-reacting means, first load-reacting means extending at a first transverse end of the base, second load-reacting means extending at a second transverse end of the base, the first load-reacting means flanking with a first longitudinal wall of the base a first segment of the connector, the second load-reacting means transversely flanking with a second longitudinal wall of the base a second segment of the connector.

4. The connection device as claimed in claim 1, wherein the base includes additional load-reacting means disposed at a longitudinal end of a longitudinal wall which is opposite the longitudinal end where the load-reacting means are disposed.

5. The connection device as claimed in claim 4, wherein the additional load-reacting means include a fin which is offset transversely with respect to the longitudinal wall and which extends mainly substantially in the same plane as that in which the bearing wall of the load-reacting means mainly extends.

6. The connection device as claimed in claim 4, wherein the pivot element is disposed longitudinally between the load-reacting means and the additional load-reacting means.

7. The connection device as claimed in claim 4, wherein the connector includes at least one support wall having an upper face participating in defining a housing of the base of the connection module, the connector comprising two segments extending parallel to one another from the upper face in the vertical direction toward the base, the support wall of the connector being extended vertically by two lateral walls disposed at the transverse ends of the support wall and extending in a direction opposite to the segments, the additional load-reacting means being disposed facing an outer face of one of the lateral walls.

8. The connection device as claimed in claim 1, wherein the connection module further includes a rotary platform rotationally mounted about an axis of rotation on the base, the axis of pivoting and the axis of rotation extending perpendicularly with respect to the longitudinal direction.

9. A wiper comprising a wiper blade and a connection device with the connection device extending in a longitudinal direction and including a connector configured to bear a wiper blade of the wiper and a connection module able to be mounted on the connector, the connection module including at lease one base pivotably mounted about an axis of pivoting on the connector, the base including at least one longitudinal wall bearing a pivot member, the connector including at least one segment on which a pivot element cooperating with the pivot member of the longitudinal wall is disposed, wherein the base includes load-reacting means which are borne by the longitudinal wall and which are configured such that the longitudinal wall and the load-reacting means are disposed transversely on either side of the segment of the connector.

10. A wiper system comprising at least one arm and a wiper, the wiper being disposed at one end of the arm, the arm being secured to the wiper by cooperation with a connection device, the connection device extending a longitudinal direction and including a connector configured to bear a wiper blade of the wiper and a connection module able to be mounted on the connector, the connection module including at least one base pivotably mounted about an axis of pivoting on the connector, the base including at lease one longitudinal wall bearing a pivot member, the connector including at least one segment on which a pivot element cooperating with the pivot member of the longitudinal wall is disposed, wherein the base includes load-reacting means which are borne by the longitudinal wall and which are configured such that the longitudinal wall and the load-reacting means are disposed transversely on either side of the segment of the connector.
